(19) United States
(12) Patent Application Publication
(10) Pub. No.: US 2025/0080365 A1
(43) Pub. Date: Mar. 6, 2025

(54) ESTABLISHING SECURE SESSION VIA PROXY DEVICE

(71) Applicant: MICRO FOCUS LLC, Santa Clara, CA (US)

(72) Inventors: Vamsi Krishna, Bangalore (IN); Daniel L. Christensen, Welmington, DE (US)

(73) Assignee: MICRO FOCUS LLC, Santa Clara, CA (US)

(21) Appl. No.: 18/457,981

(22) Filed: Aug. 29, 2023

(51) Int. Cl. H04L 9/32; H04L 9/08; H04L 9/30

(52) U.S. Cl. CPC H04L 9/3271; H04L 9/0863; H04L 9/3013; H04L 9/3073; H04L 9/3247; H04L 9/3268

(57) ABSTRACT

A first device transmits a request message to a proxy device to forward to a second device. The request message includes a public key. The second device transmits a response message to the proxy device to forward to the first device. The response message includes a cryptographic nonce and is encrypted with the public key. The first device decrypts the response message, and generates a session key based on the nonce and a pre-shared password. The first device generates a session key and transmits a challenge response encrypted with the session key to the proxy device to forward to the second device. The second device generates the session key and decrypts the challenge response with the session key. Upon the second device confirming the challenge response such that a secure session is established, the first and second devices communicate with one another over the secure session.

### BACKGROUND

Traditionally users have used computing devices locally, in that the users are physically present at their computing devices. Example computing devices include desktop, laptop, notebook, and other types of computers, as well as other types of computing devices. In local usage of a computing device, a user directly enters input at input devices of the computing device, which can include a keyboard and/or a pointing device like a mouse or a touchpad. The user directly views output displayed on a display device of the computing device, which can include an external monitor and/or an internal display.

More recently, users have also been able to remotely use or access computing devices in remote desktop sessions, such as by using remote desktop software and services. A user establishes a remote desktop session between his or her local (or client) computing device at which the user is physically present and a remote (or host) computing device that may not be physically proximate to the user. Via the remote desktop session, the user can use the remote computing device through his or her own local computing device as if the user were physically present at the remote device.

For example, a user may have a computing device at the office that the user remotely accesses from a computing device at home via a remote desktop session. As another example, a user may remotely access the computing device of another user via a remote desktop session. For instance, an administrator may remotely access an end user's computing device for troubleshooting or other purposes, regardless of whether or not the end user is present at the computing device. As a third example, a user may remotely access a computing device that does not belong to any particular user.

### BRIEF DESCRIPTION OF THE DRAWINGS

FIG. 1 is a diagram of an example system in which a secure session, such as a remote desktop session, is established between a first device and a second device via a proxy device.

FIG. 2 is a flowchart of an example method of the overall process by which first and second devices can pre-share information, establish the secure session via a proxy device using the information, and then communicate with one another over the secure session.

FIGS. 3A, 3B, 3C, and 3D are flowcharts of an example method for establishing a secure session between first and second devices via a proxy device.

FIG. 4 is a diagram of an example computing device that can implement each of the first device, the second device, and the proxy device.

### DETAILED DESCRIPTION

As noted in the background, remote desktop software and services permit a user to remotely use a remote (or host) computing device within a remote desktop session established between the remote device and a local (or client) computing device at which the user is physically present, as if the user were instead physically located at the remote device. User input at the local device is transmitted from the local device to the remote device within the session, and is treated at the remote device as if it were directly entered at the remote device. Output at the remote device is similarly transmitted from the remote device to the local device within the session, and is displayed on the local device as if the local device originally generated the output.

Remote desktop software and services can provide a way by which users can remotely access their computing devices when located away from the devices. Furthermore, remote desktop software and services can provide a way by which administrators and support personnel can remotely access computing devices of end users for troubleshooting and configuration purposes. Remote desktop software and services can also provide a way for enterprises and other organizations to better manage the computing environments of their users.

As an example of the latter, a given host computing device may maintain multiple virtual machines corresponding to different users. Each user therefore remotely uses his or her virtual machine at a client computing device within a remote desktop session established between the host device and the client device. In this scenario, users can be provided with less powerful and lower-cost client devices, such as thin client devices, that are used primarily to access the more powerful host device within remote desktop sessions.

A local computing device and a remote computing device may not be able to directly communicate with one another, however. For instance, the local and remote computing devices may not have direct network connectivity with one another. Therefore, a proxy computing device can be used to establish a remote desktop session between a local computing device and a remote computing device.

The proxy device may provide a remote desktop service with which remote desktop software at the local and remote devices communicate to establish a remote desktop session between the local and remote devices. Once a remote desktop session has been securely established between the local and remote devices via the proxy device, the proxy device is then used by the local and remote devices to communicate with one another over the secure session. That is, the local and remote devices may not be able to communicate directly with one another, but rather have to use the proxy device,

The organization or company of the local and/or remote devices may be different than that of the proxy device. For example, a service provider may provide the remote desktop service via the proxy device. The local devices may be those of administrators or support personnel of an enterprise or other organization that is a customer of the service provider, or that otherwise uses the remote desktop service. The remote devices may be those of end users of this same enterprise or other organization, or may be customers of this enterprise or other organization.

Usage of the proxy device to securely establish a remote desktop session between a local device and a remote device requires that the local and remote devices trust the proxy device, or securely establish the session in such a way that the proxy device cannot compromise an otherwise secure session. An enterprise or other organization is unlikely to trust a proxy device's remote desktop service if provided by a third-party service provider and not by the enterprise or organization itself. In such cases, a remote desktop session has to be established in such a way that the proxy device is unable to subsequently glean information exchanged between an otherwise secure session between the local and remote devices.

For instance, for an enterprise or other organization in which administrators and support personnel remotely access devices of end users, or in which end users remotely access their own devices, verifiable public-private key pairs can be used. A verifiable public-private key pair is a cryptographic key pair including a private key and a corresponding public key, where the key pair is issued by a certificate authority or other trusted party, or the public key is otherwise verifiable as belonging to the device. For example, when presented with a public key ostensibly or purportedly belonging to a device, the certificate authority that issued the device the key pair including this public key can confirm the validity of the key.

In the context of establishing a secure session between first and second devices when using a proxy device that is not trusted, the first and second devices each have its own verifiable public-private key pair. Therefore, when the first device provides its public key to the second device via the proxy device, the second device is able to verify that the public key belongs to the first device, and vice-versa. If the proxy device were, for example, to substitute the first device's public key with a different public key, the second device would be able to detect that the provided public key does not belong to the first device.

For an enterprise or other organization having hundreds, thousands, tens of thousands, or even more computing devices that may participate within remote desktop sessions, maintaining a verifiable public-private key pair for each device is problematic. Using a certificate authority to issue public-private key pairs can be cost prohibitive and managerially difficult, since a key pair has to be issued to and stored at each device that may participate in a remote desktop session, and may then have to be periodically updated. Furthermore, maintaining verifiable public-private key pairs without using a certificate authority or other key-verifying third party has proven to be even more complex, and intractable in many cases.

Another solution is to have a user present at the remote device when a remote desktop session is to be initiated with the remote device via a proxy device, in order to manually authorize the remote desktop session. The user at the remote device may enter information at the remote device that is communicated by the user of the other device, so that the remote desktop session can be securely established since the proxy device is not privy to this information. However, in many situations, a user may not be present at the remote device with which a remote desktop session is to be established, limiting the usefulness of this approach.

Techniques described herein ameliorate these and other shortcomings. The techniques permit usage of an untrusted proxy device to establish a secure session, such as a remote desktop session, between first and second devices without requiring verifiable public-private key pairs or a user to be present at each device. In particular, the techniques provide for the exchange of information between the first and second devices via the proxy device to facilitate creation of a unique session key in such a way that the proxy device is itself unable to create the session key. When the session key has been created by both devices, the secure session is effectively established. The session key is a symmetrical cryptographic key used to encrypt and decrypt communication between the first and second devices.

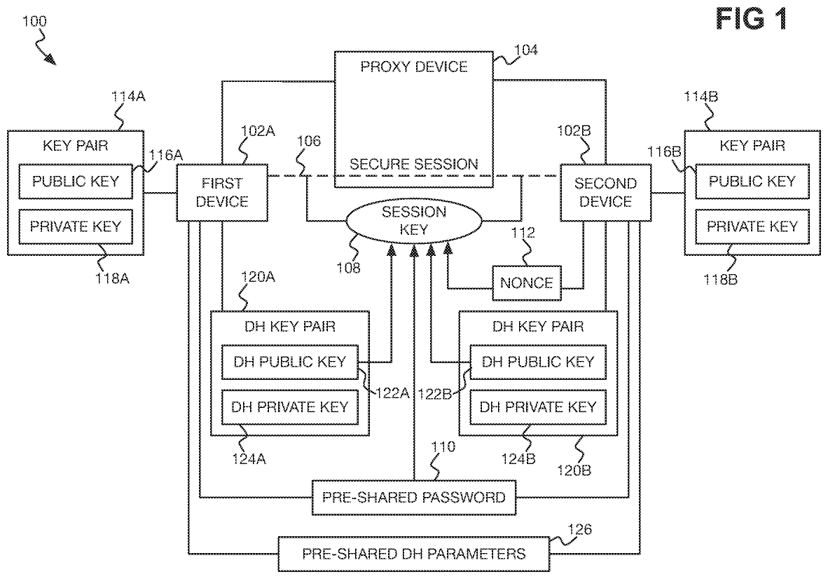

FIG. 1 shows an example system 100 in which a first device 102A establishes a secure session 106, such as a remote desktop session, with a second device 102B via a proxy device 104. The devices 102A and 102B may be computing devices. For example, the devices 102A and 102B may be desktop or laptop computers or other types of computing devices. The device 102B may be the device of an end user, which the end user is accessing remotely via the device 102A, or which a different user (such as an administrator or support personnel) is accessing remotely via the device 102A. The device 102B may be a server running a virtual machine for an end user, such that the end user remotely accesses the virtual machine via the device 102A.

The proxy device 104 may also be a computing device, such as a server or another type of computing device. The proxy device 104 may belong to a service provider that is different than the enterprise or other organization to which the first device 102A belongs. The second device 102B may belong to the same enterprise or other organization to which the device 102A belongs, or the device 102B may belong to a different party, such as a customer of the enterprise or other organization to which the device 102A belongs. The devices 102A, 102B, and 104 may be communicatively connected to one another over a network, which can include the internet, and the devices 102A, 102B, and 104 may be located at different physical (e.g., geographic) locations.

The secure session 106 is established when each of the first and second devices 102A and 102B have generated the same session key 108, which can be said to define the secure session 106. The session key 108 can be a symmetrical cryptographical key. The device 102A uses the session key 108 to encrypt information prior to communicating the information to the device 102B, and uses the key 108 to decrypt encrypted information received from the device 102B. Similarly, the device 102B uses the session key 108 to encrypt information prior to communicating the information to the device 102A, and uses the key 108 to decrypt encrypted information received from the device 102A.

The session key 108 is specific to the particular secure session 106 between the first and second devices 102A and 102B. Once the secure session 106 has been terminated by either device 102A or 102B, if a new secure session 106 is subsequently established between the devices 102A and 102B, then a different session key 108 is used. The session key 108 is generated in such a way that the proxy device 104 is unable to generate the session key 108 itself, even though the secure session 106 is established via the proxy device 104. That is, even though the session key 108 is generated using information exchanged between the devices 102A and 102B through the proxy device 104, the device 104 itself is unable to generate the key 108.

The session key 108 is generated based on a pre-shared password 110 known to both the first device 102A and the second device 102B but not to the proxy device 104. The password 110 is pre-shared between the devices 102A and 102B before the establishment of the secure session 106. The password 110 is not pre-shared using the proxy device 104, such that the proxy device 104 is not privy to the password 110. The password 110 may be stored in each device 102A and 102B at initial configuration or setup of the devices 102A and 102B. The password 110 may be electronically transmitted to and automatically stored by the devices 102A and 102B, or may be communicated to the user of each device 102A and 102B for manual entry at the device 102A or 102B. The password 110 may change periodically but not every time a secure session 106 is established. The password 110 may be a text string.

Generation of the session key 108 based on the pre-shared password 110 ensures that the proxy device 104 is unable to generate the session key 108 since the device 104 is not privy to the password 110, because the password 110 is not communicated between the devices 102A and 102B via the proxy device 104. The session key 108 is further generated based on a cryptographic nonce 112 generated by the second device 102B. The nonce 112 may be a random or a pseudo-random number. Generation of the session key 108 based further on the nonce 112 introduces randomness in the key 108, ensuring that the session key 108 is specific to a particular secure session 106 and changes each time a new session 106 is established. The nonce 112 is communicated from the second device 102B to the first device 102A through the proxy device 104, but not in plaintext.

The first device 102A has an asymmetric cryptographic key pair 114A, including a public key 116A and a corresponding private key 118A. Information encrypted using the public key 116A can be decrypted using the private key 118A, and the electronic signature of information electronically signed using the private key 118A can be verified using the public key 116A. The first device 102A generates the key pair 114A for a particular secure session 106, such that each time a session 106 is initiated a different key pair 114A is generated. The first device 102A shares the public key 118A with the second device 102B via the proxy device 104, but does not share the private key 116A with any other device.

The second device 102B similarly has an asymmetric cryptographic key pair 114B, including a public key 116B and a corresponding private key 11BA. Information encrypted using the public key 116B can be decrypted using the private key 118B, and the electronic signature of information electronically signed using the private key 118B can be verified using the public key 116B. The second device 102B generates the key pair 114B for a particular secure session 106, such that each time a session 106 is initiated a different key pair 114B is generated. The second device 102B shares the public key 118B with the first device 102A via the proxy device 104, but does not share the private key 116B with any other device.

The key pairs 114A and 114B may not be verifiable by a certificate authority or any other third party. That is, a certificate authority or any other verifying entity may not be used to issue the first and second devices 102A and 102B the key pairs 114A and 114B. As a result, cryptographic key management is eased, which is particularly helpful for an enterprise or other organization having a large number of devices. However, the second device 102B cannot verify that the public key 116A belongs to the first device 102A, and the first device 102A cannot verify that the public key 116B belongs to the second device 102B. The cryptographic key pairs 114A and 114B are therefore used in an unintuitive way in this respect.

In the implementation that has thus far been described, the session key 108 for a secure session 106 is generated based on a pre-shared password 110 known to both devices 102A and 102B and a cryptographic nonce 112 generated by the second device 102B. Therefore, randomness is introduced in the session key 108 by the second device 102B in particular. In another implementation, randomness may instead be introduced in the session key 108 by the first device 102A (and not by the device 102B), or by both devices 102A and 102B.

For example, a Diffie-Hellman key exchange technique may be leveraged so that randomness is introduced by both the first device 102A and the second device 102B. In this implementation, there are pre-shared Diffie-Hellman parameters 126 known to both devices 102A and 102B but not to the proxy device 104. The parameters 126 are not communicated between the devices 102A and 102B via the proxy device 104. The parameters 126 may be pre-shared between the devices 102A and 102B at the same time the password 110 is pre-shared. The parameters 126 may not periodically change as the password 110 does, and the parameters 126 may be hardcoded into the devices 102A and 102B (such as into program code used to establish a secure session 106). The parameters 126 may include two integers per the Diffie-Hellman key exchange technique.

The first device 102A has a Diffie-Hellman key pair 120A including a Diffie-Hellman public key 122A and a corresponding Diffie-Hellman private key 124A. The public key 122A may also be referred to as a non-secret value and the private key 124A may also be referred to as a secret value. The first device 102A generates the private key 124A, and then generates the public key 122A based on the private key 124A and the pre-shared parameters 126 in accordance with the Diffie-Hellman key exchange technique. The first device 102A generates the key pair 120A for a particular secure session 106, such that each time a session 106 is initiated a different key pair 120A is generated. The first device 102A shares the public key 122A with the second device 102B via the proxy device 104 but not in plaintext, and the device 102A does not share the private key 124A with any other device.

The second device 102B similarly has a Diffie-Hellman key pair 120B including a Diffie-Hellman public key 122B and a corresponding Diffie-Hellman private key 124B. The second device 102B generates the private key 124B, and then generates the public key 122B based on the private key 124B and the pre-shared parameters 126 in accordance with the Diffie-Hellman key exchange technique. The second device 102B generates the key pair 120B for a particular secure session 106, such that each time a session 106 is initiated a different key pair 120B is generated. The second device 102B shares the public key 122B with the first device 102A via the proxy device 104 but not in plaintext, and does not the share the private key 124B with any other device.

The session key 108 in this implementation is generated for a secure session 106 based on a pre-shared password 110 known to both devices 102A and 102B, a cryptographic nonce 112 generated by the second device 102B, and the Diffie-Hellman public keys 122A and 122B respectively generated by the devices 102A and 102B. Therefore, randomness is introduced in the session key 108 by both devices 102A and 102B. The first device 102A introduces randomness in that it generates the Diffie-Hellman public key 122A. The second device 102B introduces randomness in that it generates the nonce 112 and the Diffie-Hellman public key 122B.

The asymmetrical cryptographic key pairs 114A and 114B used for encrypting and electronically signing information communicated between the devices 102A and 102B via the proxy device 104 to establish the secure session 106 are not to be confused with the Diffie-Hellman key pairs 120A and 120B that are used for generating the session key 108 that defines the secure session 106. The session key 108 is not generated based on the cryptographic key pairs 114A and 114B. The Diffie-Hellman key pairs 120A and 120B are not used to encrypt or electronically sign information communicated between the devices 102A and 102B via the proxy device 104.

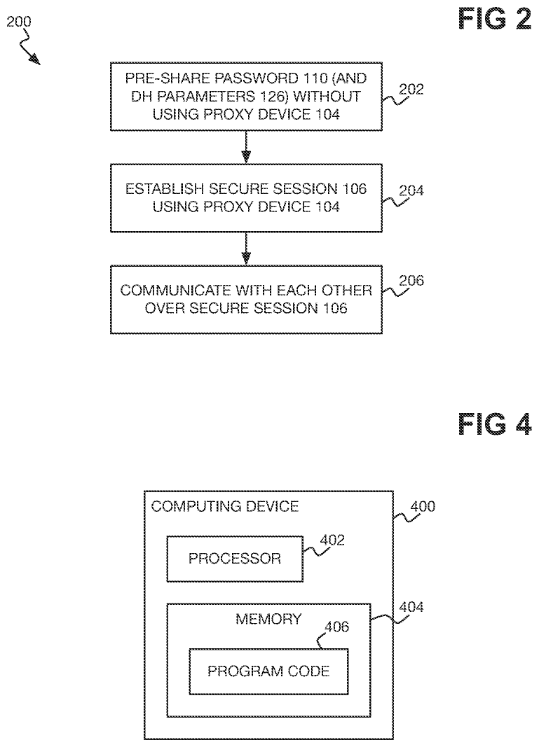

FIG. 2 shows an overall example process 200 performed by the first and second devices 102A and 102B to establish and then communicate over a secure session 106. First, the password 110, and the Diffie-Hellman parameters 126 in one implementation, are pre-shared between the devices 102A and 102B without using the proxy device 104 (202). The password 110 and the parameters 126 are pre-shared in that the devices 102A and 102B receive and store this information prior to establishing the secure session 106.

Next, a secure session 106 is established between the first and second devices 102A and 102B using the proxy device 104 (204). The secure session 106 is established by each of the devices 102A and 102B generating the same session key 108, with one device 102B or 102A effectively confirming that the same session key 108 is generated by each device 102A and 102B. The session key 108 is generated by each of the devices 102A and 102B based on at least the pre-shared password 110, and the nonce 112 generated by the device 102B and transmitted to the device 102A in encrypted manner through the proxy device 104. The session key 108 can also be generated by the device 102B based further on the Diffie-Hellman public key 122A generated by the device 102A and transmitted to the device 102B in encrypted manner through the proxy device 104. The session key 108 can also be generated by the device 102A based further on the Diffie-Hellman public key 122B generated by the device 102B and transmitted to the device 102A in encrypted manner through the proxy device 104. The session key 108 may be generated using a hash-based message authentication code (HMAC) technique.

Once the secure session 106, the first and second devices 102A and 102B communicate with each other over the secure session 106 (206). Communication over (e.g., within) the secure session 106 still occurs through the proxy device 104. The device 102A transmits information encrypted with the session key 108 to the device 102B through the proxy device 104, and the device 102B decrypts the information with the session key 108. The device 102B likewise transmits information encrypted with the session key 108 to the device 102A through the proxy device 104), and the device 102A decrypts the information with the session key 108.

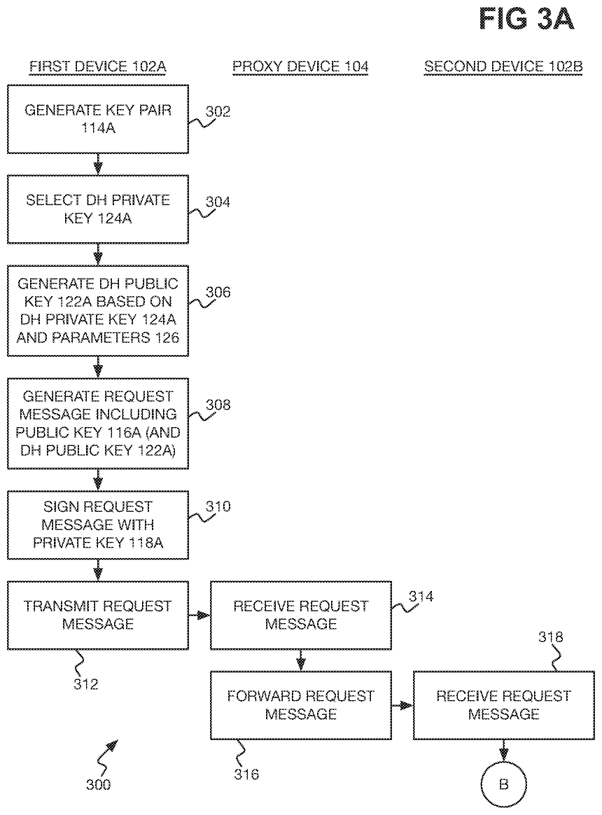

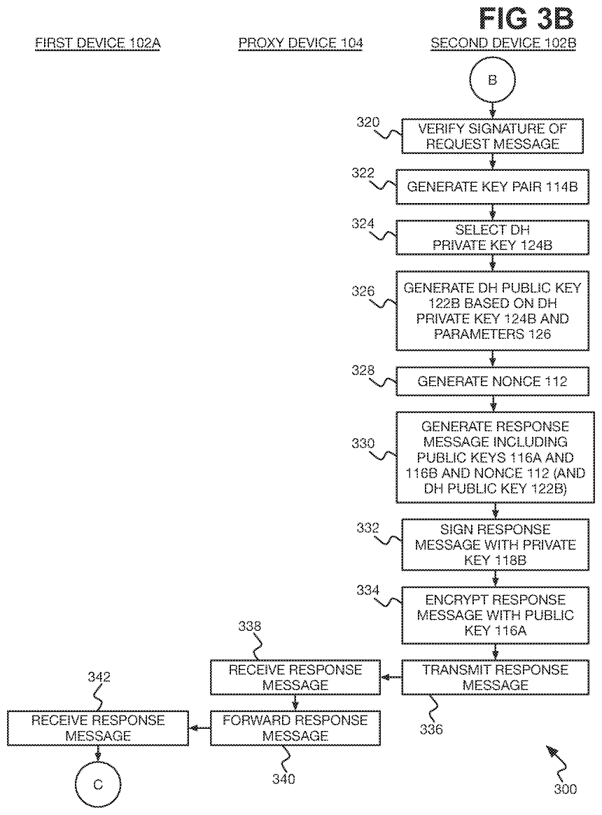

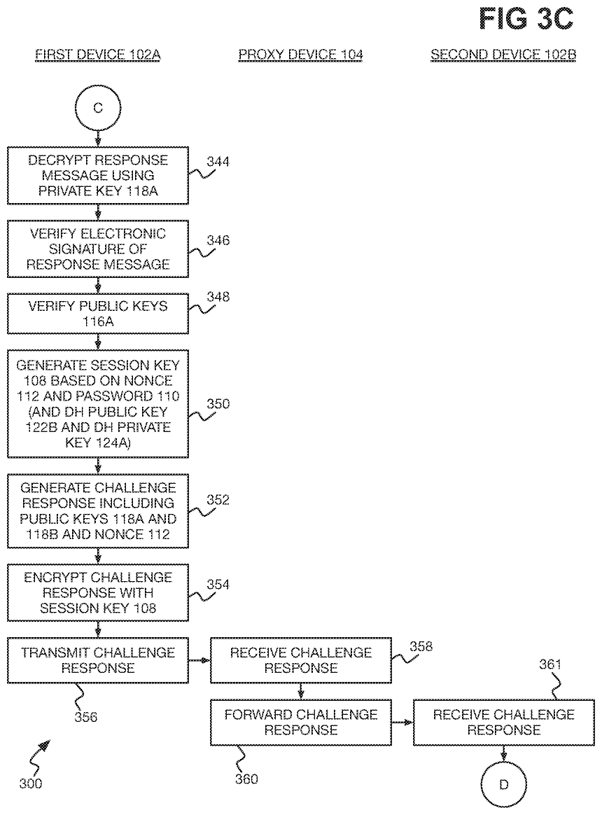

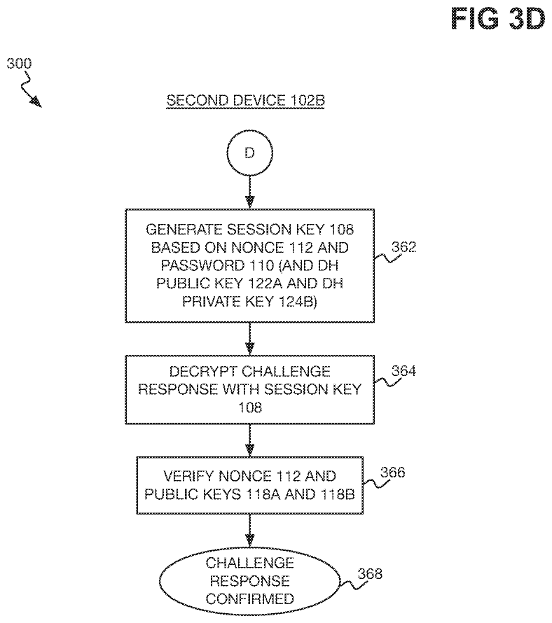

FIGS. 3A, 3B, 3C, and 3D show a specific example method 300 for establishing the secure session 106 between the first and second devices 102A and 102B via the proxy device 104. The method 300 can thus implement (204) of the process 200. The first device 102A initiates establishment of the secure session 106 in the example method 300, and the second device 102B effectively confirms that both devices 102A and 102B have generated the same session key 108 such that the secure session 106 has been established.

Referring first to FIG. 3A, the first device 102A generates the asymmetric cryptographic key pair 114A used for establishing just the secure session 106 (302). The key pair 114A includes the public key 116A and the private key 118A.

In an implementation in which the Diffie-Hellman key exchange technique is used, the first device 102A generates a Diffie-Hellman private key 124A (304), such as an integer a. The first device 102A may randomly select the private key 124A. The device 102A then generates a corresponding Diffie-Hellman public key 122A based on the private key 124A and the pre-shared Diffie-Hellman parameters 126 (306). For example, where the parameters 126 include a modulus p and a base g, which are both integers, the public key 122A is A=g^{a} mod p.

The first device 102A generate a request message for establishing a secure session 106 with the second device 102B (308). The request message can include the network address and/or other identifying information of the second device 102B. The request message includes the cryptographic public key 116A and, in the implementation in which the Diffie-Hellman key exchange technique is used, the Diffie-Hellman public key 122A as well.

The first device 102A electronically signs the request message with its cryptographic private key 118A (310), and transmits the electronically signed request message to the proxy device 104 (312). The proxy device 104 thus receives the electronically signed request message (314), and forwards the electronically signed request message to the second device 102B (316). The device 102B therefore receives the electronically signed request message from the device 102A through the proxy device 104 (318).

Referring next to FIG. 3B, the second device 102B verifies the electronic signature of the request message using the cryptographic public key 116A provided in the request message (320), and then generates the asymmetric cryptographic key pair 114B used for establishing just the secure session 106 (322). In an implementation in which the Diffie-Hellman key exchange technique is used, the device 102B also generates a Diffie-Hellman private key 124B (324), such as an integer b. The device 102B then generates a corresponding Diffie-Hellman public key 122B based on the private key 124B and the pre-shared Diffie-Hellman parameters 126 (326). Where the parameters 126 include a modulus p and a base g, the public key 122B is B=g^{b} mod p.

The second device 102B generates a cryptographic nonce 112 used for establishing just the secure session 106 (328), which may be a pseudo-random number. The device 102B generates a response message including the public key 116A of the request message, the generated public key 116B, and the generated nonce 112 (330). The response message also includes the Diffie-Hellman public key 122B in the implementation in which the Diffie-Hellman key exchange technique is being used.

The second device 102B electronically signs the response message with its cryptographic private key 118B (332), and encrypts the response message with the public key 116A of the response message (334). The device 102B transmits the electronically signed and encrypted response message to the proxy device 104 (336). The proxy device 104 receives the electronically signed and encrypted response message (338), and forwards it to the first device 102A (340). The device 102A therefore receives the electronically signed and encrypted response message from the device 102B through the proxy device 104 (342).

Referring next to FIG. 3C, the first device 102A decrypts the electronically signed and encrypted response message using its cryptographic private key 118A (344). The device 102A also verifies the electronic signature of the response message using the cryptographic public key 116B provided in the response message (346). The device 102A further verifies that the public key 116A included in the response message matches the public key 116A that the first device 102A included in the request message (348).

The first device 102A then generates the session key 108 based on at least the pre-shared password 110 and the cryptographic nonce 112 provided in the response message (350). As noted above, the session key 108 may be generated using an HMAC technique. The session key 108 may be generated in one implementation based on just the password 110 and the nonce 112. In another implementation, in which the session key 108 is also generated based on the Diffie-Hellman public keys 122A and 122B, a Diffie-Hellman secret is generated as s=B^{a} mod p, where B is the Diffie-Hellman public key 122B provided in the response message, a is the Diffie-Hellman private key 122A that the device 102A generated, and p is one of the pre-shared Diffie-Hellman parameters 126. The session key 108 may then be generated based on the password 110, the nonce 112, and the Diffie-Hellman secret.

The first device 102A next generates a challenge response including the cryptographic public key 118A the device 102A generated and the cryptographic nonce 112 and the cryptographic public key 118B provided in the response message (352). The device 102A encrypts the challenge response with the session key 108 that it generated (354), and transmits the encrypted challenge response to the proxy device 104 (356). The proxy device 104 receives the encrypted challenge response (358), and forwards it to the second device 102B (360). The second device 102B thus receives the encrypted challenge response through the proxy device 104 (361).

Referring finally to FIG. 3D, the second device 102B generates the session key 108 based on at least the pre-shared password 110 and the cryptographic nonce 112 that it previously generated (362). In the implementation in which the session key 108 is also generated based on the Diffie-Hellman public keys 122A and 122B, a Diffie-Hellman secret is generated as s=A^{b} mod p, where A is the Diffie-Hellman public key 122A provided in the request message, b is the Diffie-Hellman private key 122B that the device 102B generated, and p is one of the pre-shared Diffie-Hellman parameters 126. The Diffie-Hellman secret generated by the device 102B will match the secret generated by the device 102A, since A^{b} mod p=B^{a} mod p. The session key 108 may then be generated based on the password 110, the nonce 112, and the Diffie-Hellman secret.

The second device 102B decrypts the challenge response with the session key 108 that it generated (364). The device 102B further verifies the nonce 112 and the public keys 118A and 118B included in the challenge response (366). The nonce 112 in the challenge response is specifically verified against the nonce 112 that the device 102B generated. The public key 118A in the challenge response is specifically verified against the public key 118A included in the received request message. The public key 118B in the challenge response is specifically verified against the public key 118B that the device 102B generated.

Upon successful such verification, the challenge response is considered to have been confirmed by the second device 102B (368). Likewise, the session key 108 is considered to have effectively been confirmed by the device 102B, and the secure session 106 is considered to have effectively been established. The first device 102A and the device 102B can then use the session key 108 to encrypt and decrypt information exchanged with one another.

FIG. 4 shows an example computing device 400. The first device 102A, the second device 102B, and the proxy device 104 can each be implemented as an instance of the computing device 400. The computing device 400 includes a processor 402 and memory 404 storing program code 406. The memory 404 is an example of a non-transitory computer-readable data storage medium. The program code 406 is executable by the processor 402 to perform processing. The processing can include the parts of the process 200 and the method 300 that are performed by the instance of the computing device 400 in question.

Techniques have been described for establishing a secure session 106 between devices 102A and 102B via a proxy device 104 that may not be trusted. The secure session 106 is defined by a session key 108 that is generated at least one based on pre-shared information, including a pre-shared password 110, and based on at least a cryptographic nonce 112 to introduce randomness in the session key 108. The password 110 is not transmitted through the proxy device 104, and the nonce 112 is not transmitted through the proxy device 104 in plaintext. Establishing the secure session 106 does not require cryptographic key pairs 114A and 114B that are verifiable, such as via a certificate authority.

We claim:

1. A non-transitory computer-readable data storage medium storing program code executable by a first device to perform processing comprising:
transmitting, to a proxy device to forward to a second device, a request message for establishing a secure session between the first device and the second device, the request message including a public key of a key pair of the first device for the secure session;
receiving, from the proxy device, a response message forwarded by the proxy device from the second device, the response message encrypted with the public key and including a cryptographic nonce for the secure session;
decrypting the response message using a private key of the key pair;
generating a session key for the secure session based on the cryptographic nonce and a pre-shared password known to the first device and the second device;
encrypting a challenge response with the session key;
transmitting, to the proxy device to forward to the second device, the challenge response as encrypted with the session key; and
communicating with the second device over the secure session upon the second device confirming the challenge response such that the secure session is established.

2. The non-transitory computer-readable data storage medium of claim 1, wherein the processing further comprises generating the key pair of the first device for the secure session, such that the key pair is specific to the secure session between the first device and the second device and not to any other secure session between the first device and the second device or any other device.

3. The non-transitory computer-readable data storage medium of claim 1, wherein the public key is unverifiable with any certificate authority.

4. The non-transitory computer-readable data storage medium of claim 1, wherein the response message is electronically signed with a private key of a key pair of the second device for the secure session and further includes a public key of the key pair of the second device for the secure session,
and wherein the processing further comprises, upon decrypting the response message, verifying an electronic signature of the response message using the public key of the key pair of the second device for the secure session included in the response message.

5. The non-transitory computer-readable data storage medium of claim 4, wherein
the challenge response includes either or both of the public key of the key pair of the first device for the secure session and the public key of the key pair of the second device for the secure session.

6. The non-transitory computer-readable data storage medium of claim 4, wherein
the processing further comprises electronically signing the request message with the private key of the key pair of the first device for the secure session prior to transmitting the request message to the proxy device to forward to the second device.

7. The non-transitory computer-readable data storage medium of claim 1, wherein the response message further includes the public key of the key pair of the first device for the secure session,
and wherein the processing further comprises, upon decrypting the response message, verifying that the public key of the first device for the secure session included in the response message matches the public key of the key pair of the first device for the secure session included in the request message.

8. The non-transitory computer-readable data storage medium of claim 1, wherein the processing further comprises:
selecting a Diffie-Hellman private key of the first device for the secure session; and
generating a Diffie-Hellman public key of the first device for the secure session, based on the Diffie-Hellman private key and one or more pre-shared Diffie-Hellman parameters known to the first device and the second device,
wherein the request message further includes the Diffie-Hellman public key.

9. The non-transitory computer-readable data storage medium of claim 8, wherein the response message further includes a Diffie-Hellman public key of the second device for the secure session generated based on a Diffie-Hellman private key of the second device for the secure session and the one or more pre-shared Diffie-Hellman parameters,
and wherein the session key is generated based further on the Diffie-Hellman private key of the first device for the secure session and the Diffie-Hellman public key of the second device for the secure session.

10. A method comprising:
receiving, by a second device, a request message forwarded by a proxy device from a first device for establishing a secure session between the first device and the second device, the request message including a public key of a key pair of the first device for the secure session;
generating, by the second device, a cryptographic nonce of the secure session;
encrypting, by the second device, a response message including the cryptographic nonce with the public key;
transmitting, by the second device, the response message as encrypted with the public key to the proxy device to forward to the first device;
receiving, by the second device, a challenge response forwarded by the proxy device from the first device and encrypted with a session key;
generating, by the second device, the session key using the cryptographic nonce and a pre-shared password known to the first device and the second device;
decrypting, by the second device, the challenge response using the session key as generated by the second device; and
communicating, by the second device, with the first device over the secure session upon confirming the challenge response such that the secure session is established.

11. The method of claim 10, wherein the response message includes a public key of a key pair of the second device for the secure session,
and wherein the method further comprises electronically signing, by the second device, the response message with a private key of the key pair of the second device for the secure session, prior to transmitting the response message to the proxy device to forward to the first device.

12. The method of claim 11, wherein the challenge response includes the public key of the key pair of the second device for the secure session,
and wherein the method further comprises verifying, by the second device, that the public key of the second device for the secure session included in the challenge response matches the public key of the key pair of the second device for the secure session included in the response message.

13. The method of claim 12, wherein the challenge response includes the public key of the key pair of the first device for the secure session,
and wherein the method further comprises verifying, by the second device, that the public key of the first device for the secure session included in the challenge response matches the public key of the first device for the secure session included in the request message.

14. The method of claim 11, further comprising generating the key pair of the second device for the secure session, such that the key pair is specific to the secure session between the second device and the first device and not to any other secure session between the second device and the first device or any other device.

15. The method of claim 14, wherein the public key of the second device for the secure session is unverifiable with any certificate authority.

16. The method of claim 10, wherein the request message is electronically signed with a private key of the key pair of the first device for the secure session,
and wherein the method further comprises verifying, by the second device, an electronic signature of the request message using the public key of the key pair of the first device for the secure session included in the request message.

17. The method of claim 10, further comprising:
selecting, by the second device, a Diffie-Hellman private key of the second device for the secure session; and
generating, by the second device, a Diffie-Hellman public key of the second device for the secure session, based on the Diffie-Hellman private key and one or more pre-shared Diffie-Hellman parameters known to the first device and the second device,
wherein the response message further includes the Diffie-Hellman public key.

18. The method of claim 17, wherein the request message further includes a Diffie-Hellman public key of the first device for the secure session generated based on a Diffie-Hellman private key of the first device for the secure session and the one or more pre-shared Diffie-Hellman parameters,
and wherein the session key is generated based further on the Diffie-Hellman public key of the first device for the secure session and the Diffie-Hellman private key of the second device for the secure session.

19. A proxy device comprising:
a processor; and
a memory storing program code executable by the processor to:
receive a request message from a first device for establishing a secure session between the first device and a second device using a session key based on a cryptographic nonce and a pre-shared password known to the first device and the second device, the request message including a public key of a key pair of the first device for the secure session;
forward the request message to the second device;
receive a response message from the second device, the response message including the cryptographic nonce and encrypted with the public key;
forward the response message to the first device;
receive a challenge response from the first device encrypted with the session key; and
forward the challenge response to the second device.

20. The proxy device of claim 19, wherein the cryptographic nonce is not transmitted between the first device and the second device via the proxy device in plaintext, and the pre-shared password is not transmitted between the first device and the second device via the proxy device, such that the proxy device cannot generate the session key.
